(19) United States
(12) Patent Application Publication
(10) Pub. No.: US 2025/0036603 A1
(43) Pub. Date: Jan. 30, 2025

(54) METHOD AND SYSTEM FOR DETERMINATION OF DATA CONFIDENCE

(71) Applicant: Protexxa Inc., Aurora (CA)

(72) Inventor: Claudette MCGOWAN, Aurora (CA)

(21) Appl. No.: 18/783,637

(22) Filed: Jul. 25, 2024

Related U.S. Application Data
(60) Provisional application No. 63/528,765, filed on Jul. 25, 2023.

(51) Int. Cl. G06F 16/215; G06F 16/2458; G06F 16/25

(52) U.S. Cl. CPC G06F 16/215; G06F 16/2468; G06F 16/25

(57) ABSTRACT

The disclosure is directed at a method and system for generating a data confidence score for digital data.

### CROSS-REFERENCE TO OTHER APPLICATIONS

The disclosure claims priority from U.S. Provisional Patent Application No. 63/528,765 filed Jul. 25, 2023 which is hereby incorporated by reference.

### FIELD

The present disclosure is generally directed at the digital collection, storage and processing of data and, more specifically, is directed at a method and system for determination of a level of confidence in collected data.

### BACKGROUND

The creation of digital identities is at the core of the modern economy. The ability to accurately and securely collect and maintain digital data records is important but, at the same time, is one of today's biggest challenges. Maintenance of the collected digital data over time is also becoming increasingly difficult as economies are becoming more integrated into a globally connected world. The usefulness of any digital system used to collect, process and store data representations of legal entities is directly proportional to the system's ability to determine the reliability of the data at any point in time: at the time of data input and subsequent processing and usage.

Systems unable to accurately assess the reliability of data input and/or stored data (the garbage in, garbage out principle) are incapable of maintaining data reliability and over time, as data changes, and entropy grows, the reliability of data and therefore usefulness of these systems inevitably deteriorates. There are many systems in existence that collect, validate, and store digital data. Many perform some type of validation and matching of the digital data, mostly with respect to individual data attributes. For example, current systems validate if an address exists or detect spelling mistakes or formatting issues with phone numbers within digital data records, however, these current solutions are based on having and maintaining a current, single, uniquely identified, data record representing a single legal entity at a specific moment in time. One of the many problems with this approach is that the data collected for or at the specific moment in time will likely change such as an individual's address when they move.

With the proliferation of systems for collecting and storing digital data information, data confidence in the stored or newly collected data is decreasing. Different systems have different variations of data describing the same legal entity kept in different formats, and, over time, the data changes, systems change, and all these differences build up and decrease the reliability of the data that is stored. This poses a large problem for systems using a single record representing each legal entity. In order to function, these systems must always be able to uniquely identify the single record. This task may not be possible due to the data changes which build up over time. Using data comparison with data stored by other systems is only making the task more difficult as the number of systems and changes increases.

Systems based on a single record per legal entity, that rely on an exact match, are not able to accurately calculate confidence and reliability scores for the data stored making it difficult to have confidence in the reliability of the data. When users or other systems attempt to update the data record, it would be difficult for these systems to determine if the new input has more accurate and/or more recent or relevant data, or if the data already in the system is more accurate and relevant. As the data set describing a single legal entity naturally changes over time, and as attacks on systems become more sophisticated and more frequent these systems will become inadequate and unable to perform their primary tasks.

Therefore, there is provided a novel system and method for determining data confidence in digital data that is collected over time.

### SUMMARY

In one embodiment, the disclosure is directed at an automated determination of data confidence for digital data systems and probabilistic representation of data sets. The disclosure includes computer-based methods and systems that make use of publicly available statistical data to perform input validation and cleanup based on probabilistic calculations, as well as calculations of data confidence levels, leading to fuzzy matching and identification of related data sets and their relationship, and systems store all input and calculated data which are used in future processing to increase the accuracy and flexibility of the system. Unlike current solutions, this disclosure provides a more, not less, accurate and flexible method and system over time.

Some advantages of the present disclosure include the way the systems and methods are combined and used, the way data is collected, combined and processed, the way in which statistical data is used, the way data confidence scores are calculated and used, the way data is stored, and/or the way relationships between data entity sets are determined, stored and used.

In one aspect of the disclosure, there is provided a method of determining data confidence including parsing a digital data record to determine a set of validation components; calculating a data confidence score for each of the set of validation component by: selecting one of the set of validation components; determining if the selected validation component has been previously stored as an entry; using fuzzy matching to determine if there are other entries similar to the selected validation component; and calculating a data confidence score for the selected validation component based on the determining and fuzzy matching; and determining a digital data record confidence score based on the data confidence scores for each of the set of validation components.

In another aspect, the disclosure includes before parsing a digital data record, receiving a digital data stream; parsing the digital data stream to retrieve digital data records from the digital data stream. In a further aspect, the digital data stream is received from at least one of a statistical data source, a legal entity data source, a camera or a scanner. In a further aspect, the validation components include first name, middle name, last name, address, date of birth, place of birth and nationality. In yet another aspect, the set of validation components are associated with a name module or an address module.

In another aspect of the disclosure, there is provided, a system for determining data confidence including a statistical data module; an input validation engine; a data processing module; a statistical database; and an entity database.

In an aspect, the input validation engine includes an orchestrator component; and a set of validation modules for validating a set of validation components. In a further aspect, the set of validation modules include at least one of a name validation module or an address validation module. In yet another aspect, the input validation engine further includes a set of database for storing statistical information and digital entity data.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1 is a schematic diagram of a system for determining data confidence in an operational environment;

FIG. 2 is a schematic diagram of an input validation engine;

FIG. 3 is a schematic diagram of a statistical data engine;

FIG. 4 is a flowchart showing a method of name input validation;

FIG. 5 is a flowchart showing a method of address input validation; and

FIG. 6 is a flowchart showing a method performed by a data processing engine.

### DETAILED DISCLOSURE

The disclosure is directed at a method and system for generating a determination of data confidence in collected digital data. In one embodiment, the disclosure may provide a data confidence score in relation to digital identification data that is collected in relation to an individual being investigated.

In one embodiment, the digital identification data that is collected by the system is pre-processed and then analyzed to generate a determination of data confidence, such as in the form of a data confidence score. For example, this means that a user of the system may query the system to retrieve digital data that has been stored with a high level of confidence that the digital data is correct or relevant.

The data confidence, or data confidence score, may provide to a user of the system a level of trust that should be placed in the piece or pieces of collected digital identification data. For example, the digital data may be a digital copy of an individual's passport and the data confidence score may provide a level of trust with respect to the likelihood that the passport belongs to the individual that is being investigated.

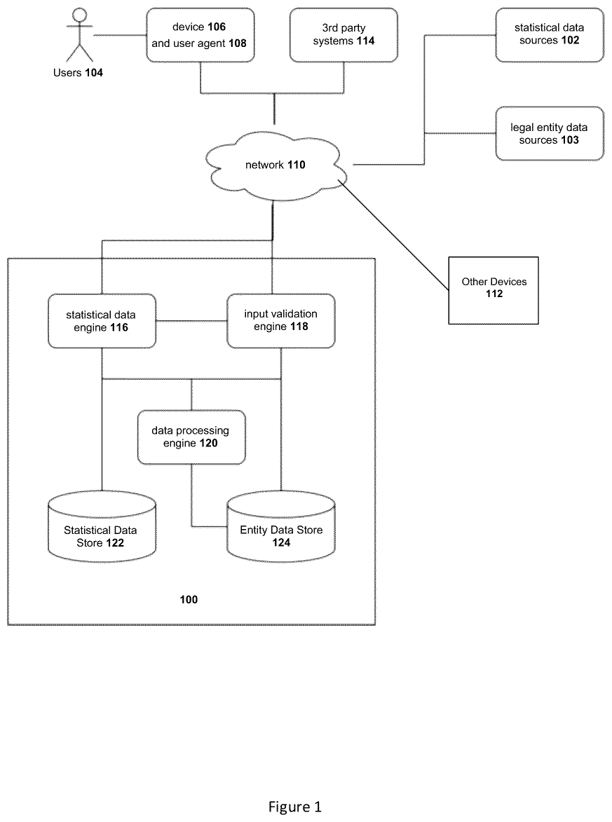

Turning to FIG. 1, a schematic diagram of a system for determining data confidence within an operating environment is shown. The system for determining data confidence, or data confidence determining system, 100, which may be implemented or seen as an entity processing system, collects and processes digital identification data that is retrieved or received from different sources that may be external or internal to the system 100. In another embodiment, the system 100 may be implemented as a software as a service (SaaS) embodiment. Examples of sources for providing digital identification data or research information to other components within the operating environment include, but are not limited to, statistical data sources 102 and legal entity data sources 103. Although only one of each source is shown, it is understood that there may be multiple statistical data sources 102 and legal entity data sources 103. As shown in the current embodiment, the statistical data sources 102 and legal entity data sources 103 are external to the system 100, however, in some embodiments, the statistical data sources 102 and legal entity data sources 103 may be stored within the system for determining data confidence 100.

The data confidence determining system 100 may also generate a data confidence score with respect to the digital identification data that is stored within the system as will be discussed below. The system 100 may also receive other digital data, such as, but not limited to, research data; support data and/or information from the different sources to assist in the determination of data confidence. Other devices 112, such as servers or other communication devices, may also be connected to the network 110 to communicate with the system 100. These other devices 112 may provide other inputs (i.e. digital data or other research information) to the system 100. Examples of other devices 112 may include cameras, general-purpose scanners and/or specialized scanners (such as ones used for reading various types of government-issued ID cards). These other devices 112 may also be seen as the different sources of digital data that may be used by the system 100.

In one example of an operating environment, the system 100 communicates with users 104 via user devices, or user communication devices, 106 that are associated with the user 104. User devices 106 may include, but are not limited to, personal computers, laptops and mobile devices such as smartphones, tablets and the like. Within each user device 106, there may be a user agent 108 that enables the user 104 to interact with the data confidence determining system 100. In some embodiments, the user agent 108 stored within the user device 106 enables the user 104 to communicate with the system 100 and vice-versa. The user agent 108 may be seen as a communication module or an application that is stored or installed on the user device 106. Other examples of user agents 108 may include, but are not limited to, web browsers, mobile device native applications, hybrid applications, personal computer native applications and the like.

Communication between the user devices 106 and the system 100 may be via a network 110 such as, but not limited to, a public or private network using known communication protocols. Although only a single user is shown in FIG. 1, it is understood that there may be any number of users 104 that are in communication with the system 100 at any time via associated user devices 106.

The environment may also include third-party systems (TPS) 114 that interact with the system 100. Each TPS 114 may include a set of applications stored within computer hardware that allows the TPS 114 to communicate with the system 100 using known communication protocols over wired or wireless networks. One example of a known communication protocol that may be used is REST API over HTTP, although other communication protocols are contemplated. In some embodiments, each TPS 114 may have their own users interacting with the system 100 through the TPS 114 or devices that are connected to the TPS 114. In other embodiments, different components of the system 100 may be stored and/or executed on one or more of the TPS 114 even thought they are shown as being separate in FIG. 1.

In the current embodiment, the system 100 includes at least one of a statistical data engine or module 116, an input validation engine or module 118, a data processing engine or module 120, a statistical data store 122 and an entity data store 124.

The statistical data module 116 collects or receives digital data from the different sources, such as at least one of the statistical data sources 102 which may then be stored in the statistical data store 122. In some embodiments, the digital data received from the data source 102 is processed before storage but in other embodiments, the digital data is stored once it is received or collected by the statistical data module 116. The data module 116 may also transmit digital data to other components of the system 100 and may also perform calculations or data processing as needed during the generation of the data confidence score. This will be described in more detail below. Both the input validation module 118 and the data processing module 120 interact with the statistical data module 116 to transmit and receive the digital data but may also access the digital data from the statistical data store 122 directly.

In use, input validation module 118 receives digital data from the user devices 106, third party systems 114, and/or legal entity data sources 103 and processes the digital data to validate the received digital data. The input validation module 118 may also retrieve digital data from the legal entity data sources 103. In one embodiment, the input validation module 118 may communicate with the statistical data module 116 to obtain digital data but it may also access the digital data directly from the statistical data store 122. Outputs from the validation module 118 may be stored in the entity data store 124 and/or used by the data processing module 120.

The data processing module 120 receives as input, an output of the input validation module 118. The data processing module 120 may also receive digital data from the statistical data module 116 and performs calculations or analysis on the received digital data. The data processing module 120 may also access the statistical data store 124 to retrieve raw statistical digital data. Results or outputs of the data processing engine 120 may be stored in the entity data store 124. These data processing module outputs may be used for future processing to improve the performance and accuracy of the data processing module 120. In other words, there is an aspect of machine learning within the data processing module 120. This is an advantage of the disclosure over current systems whose performance and accuracy deteriorate as the entropy increases over time.

As the location of the system 100 and/or its components is not an important aspect of the disclosure, FIG. 1 is only one example of how the system 100 may be implemented within one example of an operational environment. In other embodiments, implementation of the system 100 may include a set of different components with or without overlapping functionality.

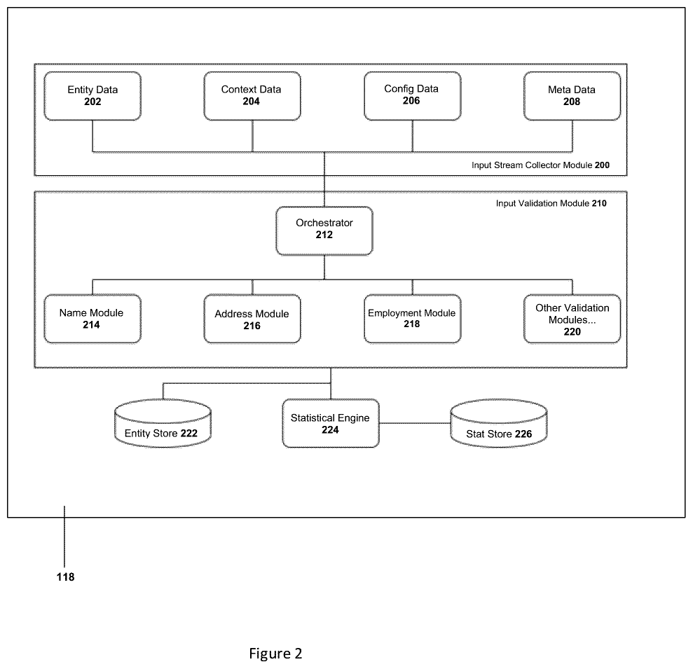

Turning to FIG. 2, a more detailed view of the input validation module 118 is shown. In the current embodiment, the input validation module 118 includes an input stream collector module 200 and an input validation module 210, an entity store or database 222, a statistical engine or module 224 and a statistical store or database 226. The entity database 222 may be the same as the entity database 124 111 and the statistical database 226 may be the same as the statistical database 122.

The input stream collector module 200 receives digital data, such in the form of digital entity data 202, digital context data 204, digital configuration or config data 206 and digital metadata 208. The different types of data 202 to 208 may also be seen as digital data streams. The input validation module 210 includes an orchestrator component 212 that communicates with the input steam collector module 200 to receive or retrieve the different digital data or data streams 202 to 208. The input validation module 210 further includes a name module or name validation module 214, an address module or address validation module 216, an employment module or employment validation module 218 and other validation modules 220. It is understood that the other validation modules may include any number of modules for validation other digital data that is received or retrieved by the system 100. The orchestrator component 212 distributes the input data streams to the relevant modules for validation of the input data stream. For example, all name information that is received from data streams 202 to 208 that relate to names is passed to the name module 214 for validation. Similarly, all address information received in the data streams 202 to 208 are transmitted to the address module 216 for validation. In some embodiments, the validation modules 214 to 220 may run in parallel to generate various calculated probabilities and confidence level numbers which will be later used by the data processing engine 120 to generate data confidence scores for the entire data set. The data processing module 120 may also determine links based on similarity of attributes and calculated values of this data set to already stored data sets.

In one example of operation, one or more entity data streams (seen as entity data 202) is received by the input validation module 118 through the input stream collector module 200. The entity data stream 202 or streams may include several different kinds of data streams. Examples of data streams include but are not limited to, various companies selling contest participant digital data entries that include digital data such as, but not limited to, first name, last name, email, and some other data like postal code, or age. There may also be other “context” data such as, but not limited to, location. Another example of a data stream may be digital data received from social media application programming interfaces (APIs) or an event stream. A governmental licensing bureau digital data source may also provide a digital data stream that includes information from public records such as, but not limited to, court filings and the like. Other digital data streams may include data from loyalty and/or credit bureaus.

After being received by the system 100 (via the input validation module 118), the entity data 202 is then subject to processing. In one embodiment, the digital entity data 202 may include, but is not limited to, first name, last name, and/or relevant information relating to an individual of interest or individual being investigated. Other digital entity data may include, but is not limited to, address, date and/or place of birth or other attributes that are available from a source document or directory inputted into the system 100 by a system user, a third-party system, or the individual themselves. It is understood that these are examples only and that other types of information relating to the entity may be received within the entity data stream 202.

Digital context data 204 is also received and refers to, but is not limited to, the information available about the source of the digital entity data 202 such as the device that was used to input the entity data 202 and other similar information. Sources of the entity data 202 could be, but are not limited to, government-issued documents, documents issued by institutions, employment documents, etc. Other digital data sources may include files produced as extracts from computer systems that store such data. In other embodiments, the source of data could be received from the individual of interest themselves. Digital context data may be identified by a document name, a document type, issue date(s), issuing authority, document numbers and the like. With known documents, such as a passport, the presence and/or absence of information about the document (such as issuing authority) in relation to the document type is important information as the system may use the presence or absence of such information to assist in determining or generating the data confidence scores. If, for instance, the device or source that is providing the digital data is a card reader and the source document is a driver's license, there is an expectation that an expiry date would be available within the received digital data. The absence of an expiry date in the received digital data may impact and reduce the data confidence score relating to the received digital driver's license data. This is an advantage of the current system in that received data is pre-processed to determine authenticity or an initial confidence level of the entity data that has been received.

Digital configuration data 206 (related to the digital entity data 202) is typically found in all software-based communications. In some embodiments, the digital configuration data 206 may be related to the type of data source, data stream, etc.

For example, a map for the system of the disclosure may be used to locate the data source or type of data source based on incoming data format. For example, if the data source of information source is a driver license, such that source==“Ontario Ministry of Transport Driver's license”, the data source may be represented as OMT_D_v3.4 which is delegated as configuration data and processed and/or stored by the system 100. Examples include the number of threads, URLs, user names, logging levels, libraries and algorithms used, and similar.

Digital meta data, or metadata, 208 is similar to configuration data 206 but is specific to the user or third-party system submitting the digital data, system, and/or context. For example, digital metadata 208 may provide a data source confidence score for a specific user or class of users, system or class of systems. For example, if the digital entity data that is received is a bar code readout or bar code information from an Ontario Health Card and the source is a health care provider system, the system 100 may confirm that the health care provider system is registered as a trained operator such that there is a higher confidence in the digital data information that is provided to the system by this health care provider system even when the digital data is being transmitted or received in real-time. The resulting data confidence score for this digital data will be higher when calculated due to the data source confidence score as calculated by a trained machine learning model.

In some embodiments, the machine learning model may require training to provide an initial quality number for each piece of data or data stream prior to the confidence score processing. For example, if digital data that is directly received via an Ontario Health Card from an established health care provider system is assigned a data source confidence level of 10, self scanning of an Ontario Health Card by a user via a known mobile application may be assigned a data source confidence level of 8, while scanning via an unknown module application may be granted a data source confidence level of 6. Other examples may include where the Ontario Health Card data is entered via keyboard input, the data source confidence level may be a 6; and if the Ontario Health Card data is entered by the user, the data source confidence level may be set at 5. Based on these numbers, the system may then include the rest of data stream and calculate overall data confidence scores. As will be understood, these are provided as examples of processing variables that may be used but that the system is not limited to a specific format or type of digital data. A typical example would be the date format used on Ontario driver's licenses when read through the bar code, magnetic strip, and/or visual reader.

All of the digital data that is received via by the input stream collector module 200 is then transmitted to and received by the orchestrator component 212 which then transmits all relevant information to the different modules 214 to 220 to perform validation of the digital data that has been received. For example, the name module 214 can validate the authenticity of the name within the entity data stream and provide an initial data confidence score. This initial data confidence score associated with the name and information relating to the entity data that was validated can then be stored in one of the stores or database 222 or 226 or both. Similar actions may be taken by the other modules 216 to 220.

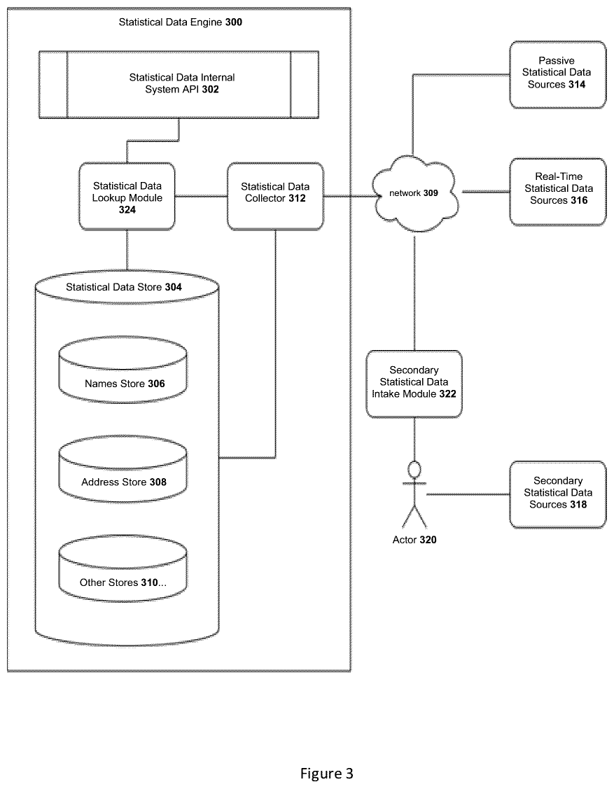

Turning to FIG. 3, a schematic diagram of a statistical data module is shown. The statistical data module 300 of FIG. 3 may be the same as the statistical data engine 116 of FIG. 1. In operation, the statistical data module 300 provides assistance with respect to operation of the input validation module 210 and data processing module 120.

In the current embodiment, the statistical data module 300 includes a statistical data internal system application programming interface (API) 302 that provides or facilitates access to a statistical data store or database 304 to the other components of the system 100. In some embodiments, the statistical data store 304 may include a name store or database component 306 for storing statistical digital data about names, an address store or database component 308 for storing statistical digital data relating to addresses and other stores or database components 310 for storing statistical digital data relating to other types of statistical digital data. In some embodiments, the statistical data module 300 includes a statistical data collector component 312 that provides the functionality to collect and/or store statistical data independently. The collector component 312 may be implemented via at least one module that is stored within one of the components of the system. In operation or use, the collector component 312 pulls, receives or retrieves digital data from various statistical data sources such as a passive statistical digital data source 314; a real-time statistical digital data source 316 and/or secondary statistical digital data sources 318 associated with users 320. The statistical digital data source 318 may also be associated with a secondary statistical digital data intake module 322.

A statistical lookup module 324 is located between the API 302 and the data store 304. In other embodiments, the API 302 may also perform calculations or analysis of digital data or perform other types of processing on the digital data.

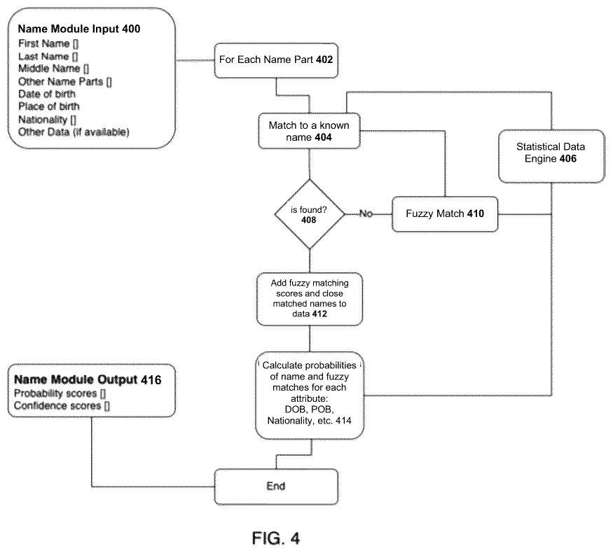

Turning to FIG. 4, a schematic hybrid diagram of components of a name input validation module (such as validation module 214 of FIG. 2) and a method of generating a data confidence scored based on name validation is shown. As discussed above, the name input validation module may be seen as one type of input validation module. It is understood that other input validation modules (such as the other modules 216 to 220 shown in FIG. 2) may operate in a similar or identical manner with different types of inputs or entity being validated along with the generation of a data confidence score.

As shown, in FIG. 4, the name validation module 214 may include or receive input 400 that relates to different digital entity data. The digital data may be received in the form of a data stream or the system may process any received digital data to parse our information relevant or required by the name input validation module. In one embodiment, the input digital data may be received from the entity data input stream referenced as 202 in FIG. 2 and described above. The information within the name validation module may be separated or broken down into validation components such as, but not limited to, first name, middle name, and last name. The input can include other parts including date of birth, place of birth, nationality and other data as validation components.

At least one of the validation components is then selected (402) and processed to validate the accuracy or authenticity of the selected validation component. This may be repeated for each of the validation components or a selected number of validation components.

For the selected validation component, the system then attempts to match the text of the validation component (for example a first name) to a list of known first names (404). In one embodiment, the system compares the text of the selected validation component with text or digital that is stored in the statistical data module. For example, if the validation component is first name and the received name is “John”, a check is performed by or with the statistical data module to determine if there is a match for “John” as a first name.

The system then determines if a match is found (408). If a match is not found, the system then uses fuzzy matching to determine if the first name can be validated (410). In one embodiment, the fuzzy matching provides several possible matches along with a validation score associated with each of the possible matches. The system may also provide information about the matching such that it could be used to make an inference about the probability of user input error, for instance, but not limited to, a typing error, a scanning error, a reader error and the like.

If at least one match is found, the system then adds the validation scores from the fuzzy matching process (410) (if performed) and any closely matched names from the data store (412). The system then calculates a probability that the text of the validation component that is being validated is one of the possible matches and a data confidence score based on that probability (414). This may be repeated for each of the validation components that need to be validated. An output is then generated (416) for each of the validation components that were validated based on the probability scores and data confidence scores.

For example, assume that there are multiple entries with the first names Liz, Lis, Liza or Lisa. It should be noted that on a keyboard, the “s” is close to the “z” and that the names are very similar. The probability for these names to be the same is high. However, as outlined above, how digital data is entered into or received by the system and from where affect the data source confidence score or accuracy of the stored digital data. In some embodiments, there may be another type of confidence score to account for language differences. In some languages, there may be different sounding names that are the same, such as, but not limited to, Alexander and Sasha. Sasha on official docs may receive a low data source confidence score but on social media or a school book, it may receive a higher score.

In one example, a validation component may be the name text “Jonh”. As understood, this is close to “John” and there is a probability that the user entering the information typed the name incorrectly into the system. This would be reflected in the fuzzy matching scores and data confidence scores. Similarly, the validation component may be the name text input “Honh” since H and J are adjacent on the QWERTY keyboard. This would also be reflected in the fuzzy matching scores and data confidence scores.

However, if the context data indicates that the user or the device entering the information was scanned and not manual input, the probability that the name text should be John (in both cases) is lower than if the information was manually entered. This provides one example of how context data, fuzzy matching, and statistical data may be used by the name input validation module to analyse input data and provide the output 416 which is later combined by the data processing engine (referenced as 120 in FIG. 1).

At this stage in this module, the system is only looking at the name parts of the input data set and conducts a comprehensive analysis using all classes of input data identified in 200 of FIG. 2 as well as statistical data.

As will be understood, the popularity of specific names in specific locations, cultures, and languages, changes over time. In one embodiment, the statistical data module 116 of the disclosure collects, maintains, and stores information relating to the popularity on a regular basis based on geographical location, language, country and so on. In some embodiments, the name input validation module 214 may use this popularity data along with the input data (entity data), the date and place of birth, to further improve probability and/or confidence scores. This may be done for the fuzzy-matched names as well, where applicable. The calculated values are a part of the output 409 which is later combined with other similar scores and used by the data processing engine.

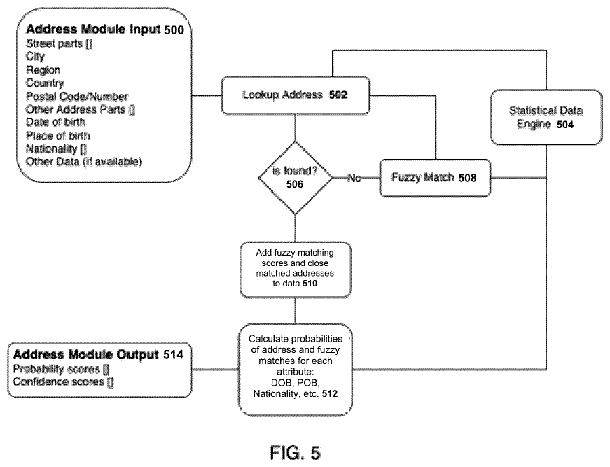

Similar to the schematic hybrid name input validation module and method shown in FIG. 4 and discussed above, a hybrid address input validation module and method is schematically shown in FIG. 5. The combination module and method shown in FIG. 5 provides one embodiment of input validation for entity data attributes that are a part of the address validation component.

Initially, input address data 500 is received by the address validation module 216. The input address data 500 may include address information such as, but not limited to, street name, city, region, country, postal code/number, other address parts, date of birth, place of birth or nationality which may be seen as address validation components. In some embodiments, machine learning models whereby an increased number of input variables may be contemplated.

Initially, the system selects an address validation component, such as the street name (502) and determines if a match for that street name is found in a data store or database (506). This may be performed in conjunction with the statistical data engine which may provide a lookup table or information for the comparison.

If there is no match, the system then uses fuzzy matching (508) to determine what the text in the address validation component might be or to determine other existing stored text that have similarities with the selected address validation component. This may be performed in a similar way to the one described above.

Once a match is found, the fuzzy matching probability scores for the address validation component are added to other matches (510) that were found in (506). to generate probability scores and/or data confidence scores that are used as part of the output for the address validation module. As with the name input validation module, other address validation components, such as, but not limited to, date of birth, place of birth, the input metadata, and the input context data may all be used to perform further calculations of probabilities and determine the individual confidence scores (512). This information may then be provided as an output (514) by the address validation module and may be used by the data processing engine and stored to be used in future processing.

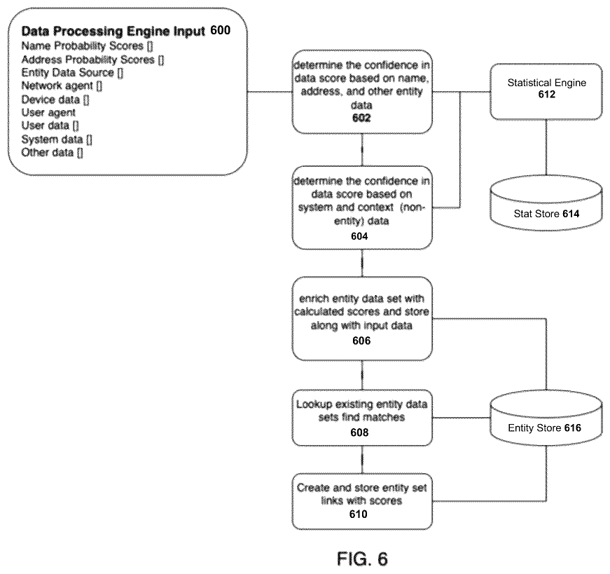

Turning to FIG. 6, a schematic diagram of a method performed by a data processing engine is shown. The method may be seen as a method of generating a data confidence score for a specific piece of digital data. Data or input 600 that is provided to the data processing engine 120 may include, but is not limited to, name probability scores, address probability scores, entity data source, network agent, device data, user agent, user data, system data and/or other data. This input 600 may be received from other components of the system such as, but not limited to, the individual validation modules or data streams from users and/or data sources.

The input data 600 may be further enriched with data from a statistical data store 614 via a statistical data engine 612. All of this information is then be processed by the system to determine a set of entity confidence factors, or scores, (602) based on the name, address or other entity data. In one embodiment, the input engine is focussed on specific input data attributes such as name or address. In another embodiment, the data processing engine results from previous calculations are combined and processed to further enhance the accuracy and flexibility of confidence levels or confidence scores.

The system then determines a system and context confidence scores (604) based on the processing of non-entity data that is part of the input 600 or received from the statistical data store 614. The entity data is then updated to include the set of entity confidence scores and/or the set of non-entity confidence scores and stored in one of the data stores, such as the entity data store 616.

The system may then lookup existing data sets to find matches (608) and create and store entity set links with scores (610). In other words, for (608), the confidence scores are used to look up and find matches of this data set with respect to other data sets already stored in the entity store 614. Once these matches are identified fuzzy matching scores are analysed and links and stored to allow for greater accuracy and flexibility of the stored data and to facilitate easier processing in the future.

It is understood that the method may be performed entirely by the data processing engine or the process may be shared between difference components of the system. In some variations, this would be a preferred implementation choice as it would allow for better performance and greater flexibility of the system. It is important to note that these (606) and (608) can be performed at the time the data is used to find and identify entity sets rather than to create and/or update them. This is another reason that (606) and (608) may be implemented or executed in one or more separate components without impacting operation of the disclosure. In fact, one of the advantages of the disclosure is that the way data is processed and stored allows for identifying specific entities as clusters of data sets linked through matching scores forming a probabilistic distribution. This, identifying individual entities as probabilistic distributions of data set clusters, is a more accurate representation of real, individual entities such as people, companies, and other similar entities.

In some embodiments, the user may be able to search for or confirm an identity of a person of interest based on pre-determined attributes, such as, but not limited to, first name, last name and the like. Based on the request, the system may prompt users to determine if they wish to retrieve or receive a pre-determined listing of identities based on the number of updates to the stored digital data associated with the request, In some embodiments, the user may determine a time frame within which the updates to the digital data were performed such as, but not limited to ten days or ten weeks. The list of identities may also be generated based on a number of records per cluster where a cluster can be seen as a number of records with high probability of being related to or associated with a single, or the same, individual. These may also be seen as duplicate records.

In one example of a calculation, assume that there are three entries (or three pieces of stored data) from different sources that have been received at different times (say over a period of a year) and then processed. An entry may be seen as a set of input data received (together in a “bundle”) from a single source.

If a user requests details for an individual based on first and last name, the system may then search or propagate through digital entries that are “found” by the system based on a probability that one or more could be a match for the first and last name query. In one embodiment, the probability score may be a floating-point number greater or equal to 0 and less than or equal to 1 which represents how close the data in each of the entries is to the first and last name query. It should be noted that the probability score is not related to the quality and quantity of the data of each entry. The calculated confidence score is a measure of the quality of data. To receive usable data, it is beneficial to use both of these measures.

For example, assume that three data sources or newsrooms “The Times of London”, “Wall Street Journal”, and “Daily Mirror” are reporting on the same event. The information found in all three sources would have a high data source confidence score as the information or data is confirmed by three reputable sources. If the digital data is only found in one of the three data sources, the digital data would be assigned a lower confidence score as it is not confirmed by other data sources. As will be understood, this is a simplification of the disclosure that the more detailed or integrated confidence score determinations may be achieved, such as based on machine learning models. When the machine learning models are trained, a subset of data is used so that if the system encounters the data that it recognizes from its previous training, the system may be more confident, however, in most scenarios, machine learning models will encounter data it has never seen so that they system of the disclosure may still work with lower confidence scores applied to the different data.

The reliability of data in the present disclosure is measured as a confidence scores matrix representing a set of calculated probabilities of data correctness at a point in time starting from the time the entity data set stream is received. To accurately measure the reliability of an entity data set, having and using the data set alone is insufficient. The measurement must also take into account, but is not limited to, metadata that describes the data, context data that describes data input, system configuration data, and any other relevant data about but not limited to the entity data, the system, context and actors at the point, but not limited to, of data input. The system in the present disclosure collects and stores with the entity data set such additional relevant data and collects and uses other available relevant data such as, but not limited to, statistical data.

Digital systems can never claim with 100% certainty that the data set representing a legal entity that is received by the system and/or stored within the system is 100% correct (accurate) and reliable at any time.

This disclosure calculates and stores data reliability as a confidence scores matrix together with the entity data set and all the other data collected at the same time with the entity data set used in the calculations of confidence scores. Functionality provided by embodiments of the disclosure include, but is not limited to, accessing the original and enriched data set at any point in time; reprocessing, recalculating confidence and other scores using the same or different system configuration and/or related and relevant additional data such as but not limited to statistical data; comparing data and calculated scores at different points in time to make inferences about the data and/or reliability; and/or calculate and recalculate similarity and proximity between data sets at any point in time.

The present disclosure preserves complete data input streams and is capable of reprocessing any entity data set, and/or a collection of related data sets, and/or recalculate relationships between data sets at any point in time. This preserves the integrity of the system and data as well as increases the reliability of the data and therefore the usefulness of the system. Over time the reliability of the data in the system is increasing.

Legal entities in the present disclosure are represented in the system as clusters of related entity data sets along with, but not limited to, the data reliability of each set measured as a confidence scores matrix, the relationship between each set represented with the proximity scores matrix, and the reliability of relationship proximity scores. The result of a search for a legal entity would be this probabilistic distribution of data sets described, which is a more accurate digital representation of any legal entity (than would be a single record typically produced by currently available systems).

Advantages of the current disclosure include, but are not limited to: 1) not requiring direct end-user input or a presence of a human user; 2) not requiring end-user behaviour; 3) does not make pre-determined decisions; 4) can accept many different data and document input methods; 5) can accept and process many entities/identities at the same time; and/or 6) can re-process data, produce different outputs and optimization.

As discussed above, the system of the disclosure may be implemented using a combination of software, hardware and/or firmware. In one embodiment, the system includes a computer readable medium that includes computer-executable code that, when executed, provide a method of determining data confidence.

In the preceding description, for purposes of explanation, numerous details are set forth in order to provide a thorough understanding of the embodiments. However, it will be apparent to one skilled in the art that other arrangements and embodiments would be feasible.

The above-described embodiments are intended to be examples only. Alterations, modifications and variations can be affected to the embodiments by those of skill in the art without departing from the scope of the application, which is defined solely by the claims appended hereto.

What is claimed is:

1. A method of determining data confidence comprising:
parsing a digital data record to determine a set of validation components;
calculating a data confidence score for each of the set of validation component by:
selecting one of the set of validation components;
determining if the selected validation component has been previously stored as an entry;
using fuzzy matching to determine if there are other entries similar to the selected validation component; and
calculating a data confidence score for the selected validation component based on the determining and fuzzy matching; and
determining a digital data record confidence score based on the data confidence scores for each of the set of validation components.

2. The method of claim 1 further comprising, before parsing a digital data record:
receiving a digital data stream;
parsing the digital data stream to retrieve digital data records from the digital data stream.

3. The method of claim 2 wherein the digital data stream is received from at least one of a statistical data source, a legal entity data source, a camera or a scanner.

4. The method of claim 1 wherein validation components comprise first name, middle name, last name, address, date of birth, place of birth and nationality.

5. The method of claim 1 wherein the set of validation components are associated with a name module or an address module.

6. A system for determining data confidence comprising:
a statistical data module;
an input validation engine;
a data processing module;
a statistical database; and
an entity database.

7. The system of claim 6 wherein the input validation engine comprises:
an orchestrator component; and
a set of validation modules for validating a set of validation components.

8. The system of claim 7 wherein the set of validation modules comprise at least one of a name validation module or an address validation module.

9. The system of claim 7 wherein the input validation engine further comprises:
a set of database for storing statistical information and digital entity data.
